(19) United States
(12) Patent Application Publication
(10) Pub. No.: US 2006/0233531 A1
(43) Pub. Date: Oct. 19, 2006

(54) Content reproduction apparatus and subtitle reproduction method

(75) Inventors: Haruhiko Toyama, Kawasaki-shi (JP); Tooru Kamibayashi, Chigasaki-shi (JP); Hideki Mimura, Yokohama-shi (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: Kabushiki Kaisha Toshiba, Minato-ku (JP)

(21) Appl. No.: 11/435,586

(22) Filed: May 17, 2006

Related U.S. Application Data
(63) Continuation of application No. PCT/JP06/30403, filed on Feb. 24, 2006.

(30) Foreign Application Priority Data
Feb. 25, 2005 (JP) 2005-050987

(51) Int. Cl. H04N 7/00

(52) U.S. Cl. 386/95

(57) ABSTRACT

A content reproduction apparatus includes a content reproduction unit which reproduces a content data item from a recording medium, the recording medium storing the content data item and a plurality of segment data items which are described in a structured document description language, the segment data items corresponding, respectively, to a plurality of time periods which are segments of a reproduction time period required for reproducing whole of the content data item, and each of the segment data items, which corresponds to each of the time periods, including a group of subtitle data items to be reproduced within the each of the time periods, and a subtitle reproduction unit which reproduces the group included in the each of the segment data items while a partial content data part which is to be reproduced within the each of the time periods is reproduced by the content reproduction unit.

### CROSS-REFERENCE TO RELATED APPLICATIONS

This is a Continuation Application of PCT Application No. PCT/JP2006/304031, filed Feb. 24, 2006, which was published under PCT Article 21(2) in English.

This application is based upon and claims the benefit of priority from prior Japanese Patent Application No. 2005-050987, filed Feb. 25, 2005, the entire contents of which are incorporated herein by reference.

### BACKGROUND OF THE INVENTION

1. Field of the Invention

The present invention relates to a method of reproducing subtitle data corresponding to content data in a recording medium, and a content reproduction apparatus using this method.

2. Description of the Related Art

In a video standard of an existing DVD, a subtitle of bitmap information can be stored as a sub-picture in an optical disk. It is demanded in the video standard of a next-generation DVD that the subtitle be stored in multiple languages or that the subtitle be downloaded and added from a network. Since the subtitle stored as the bitmap information has a size program, it is demanded that the subtitle be held in a text form. As a method of holding the subtitle in the text form, there is an individually defining method, but this is expected to be replaced by a standard method using an XML standard.

On the other hand, in a W3C timed text working group, a timed text as a markup language to form subtitle information into an XML document is being formulated by applying SMIL, which describes a reproduction order of multimedia (see, e.g., Document 1: Internet <http://www.w3.org/AudioVideo/TT/>). This limited sub-set was published as a working draft (DFXP) in November, 2004 (see Document 2: Timed Text (TT) Authoring Format 1.0? Distribution Format Exchange Profile (DFXP), [online], November 2004, Internet <http://www.w3.org/TR/ttaf1-dfxp/>).

The timed text describes subtitle information and layout in a sub-set syntax, and describes display start time information and display continuing time for each paragraph.

In an optical disk the seek time in moving a head is slow. Data multiplexed into content data such as video data or audio data to be read as needed is more efficiently accessed at random. To handle a plurality of multi-language subtitle files with good efficiency, it is better to handle subtitle data divided depending on a reproduction segment than to read all the subtitle data at the beginning of the reproduction.

Even in a case where the subtitle information is an XML document such as a timed text, when the information is downloaded from the network, it is more efficient to divide the XML data by the reproduction segment before downloading the data. Therefore, it is demanded that only fragments of the XML document divided into a plurality of files be reproduced.

However, since the XML document cannot be simply divided in a syntactical relation, and further in a timed text form, a display start time of each subtitle paragraph is represented by a time elapsed immediately after the displaying of the subtitle paragraph is completed. Therefore, the display time cannot be reproduced from the divided fragments only.

Therefore, heretofore, in a case where the subtitle data is described in XML or the like, and downloaded from the network, there is a problem that the divided subtitle data is successively read, and the subtitle cannot be easily reproduced in synchronization with the reproduction of the content data in the recording medium.

Therefore, an object of the present invention is to provide a subtitle reproduction method and a content reproduction apparatus using the subtitle reproduction method in which subtitle data is divided and stored, subtitle is easily reproduced in synchronization with the reproduction of content data in a recording medium, and the subtitle data is suitably accessed at random.

### BRIEF SUMMARY OF THE INVENTION

According to embodiments of the present invention, a content reproduction apparatus includes: a content reproduction unit which reproduces a content data item from a recording medium, the recording medium storing the content data item and a plurality of segment data items which are described in a structured document description language, the segment data items corresponding, respectively, to a plurality of time periods which are segments of a reproduction time period required for reproducing whole of the content data item, and each of the segment data items, which corresponds to each of the time periods, including a group of subtitle data items to be reproduced within the each of the time periods; and a subtitle reproduction unit which reproduces the group included in the each of the segment data items while a partial content data part which is to be reproduced within the each of the time periods is reproduced by the content reproduction unit.

According to the content reproduction apparatus described in the embodiments of the present invention, subtitles can be easily reproduced in synchronization with the reproduction of the content data in the recording medium.

### BRIEF DESCRIPTION OF THE SEVERAL VIEWS OF THE DRAWING

FIG. 1 is a diagram showing a constitution example of a content reproduction apparatus;

FIG. 2 is a diagram showing one example of an XML document including the whole subtitle data;

FIG. 3 is a diagram showing a display example of a subtitle in a display screen of a display device disposed in the content reproduction apparatus;

FIG. 4 is a diagram showing subtitle data described in XML of FIG. 2;

FIG. 5 is a diagram showing a storage example of content data and subtitle data in a disk;

FIG. 6 is a diagram showing one example of divided subtitle XML data;

FIG. 7 is a diagram showing one example of common subtitle XML data;

FIG. 8 is a diagram showing one example of subtitle reproduction control information;

FIG. 9 is a diagram showing each time period of the content data, and the divided subtitle XML data corresponding to the time period for reproducing a subtitle text to be reproduced within each time period;

FIG. 10 is a diagram showing one example of reproducible divided subtitle XML data and showing reproducible divided subtitle XML data corresponding to time period 401;

FIG. 11 is a diagram showing another example of the reproducible divided subtitle XML data and showing reproducible divided subtitle XML data corresponding to time period 402;

FIG. 12 is a diagram showing still another example of the reproducible divided subtitle XML data and showing reproducible divided subtitle XML data corresponding to time period 403;

FIG. 13 is a diagram showing an XML document including the whole subtitle data, the common subtitle XML data of a <head> element extracted from the XML document, and a portion which does not include any <head element>;

FIG. 14 is a diagram showing a procedure for generating the divided subtitle XML data from the portion which does not include any <head element> extracted from the XML document including the whole subtitle data;

FIG. 15 is a diagram showing a procedure the reproducible divided subtitle XML data from the divided subtitle XML data;

FIG. 16 is a diagram showing one example of subtitle reproduction control information including a prefetch time for each divided subtitle XML data;

FIG. 17 is a flowchart showing a procedure for generating the common subtitle XML data of the <head> element only and the divided subtitle XML data which does not include any <head element> from the XML document including the whole subtitle data; and

FIG. 18 is a flowchart showing a processing operation of reproducing a subtitle in a subtitle reproduction unit.

### DETAILED DESCRIPTION OF THE INVENTION

An embodiment of the present invention will be described with reference to the drawings.

Here, there will be described an example of a content reproduction apparatus to reproduce a recording medium such as an optical disk in which content data including video or audio data, subtitle data and the like are recorded.

The content reproduction apparatus in the present embodiment displays the subtitle data recorded in the recording medium or the subtitle data downloaded from a network while reproducing the content data in the recording medium.

Here, the subtitle data is prepared for each language with respect to the content data recorded in each recording medium (hereinafter referred to as the disk), and each subtitle data item of each language is described in a structured document description language such as an extensible markup language (XML) or a hyper text markup language. It is assumed here that a document is an extensible markup language (XML) document described in a timed text in accordance with, for example, DFXP.

First, there will be described the XML document of the subtitle data described in the timed text.

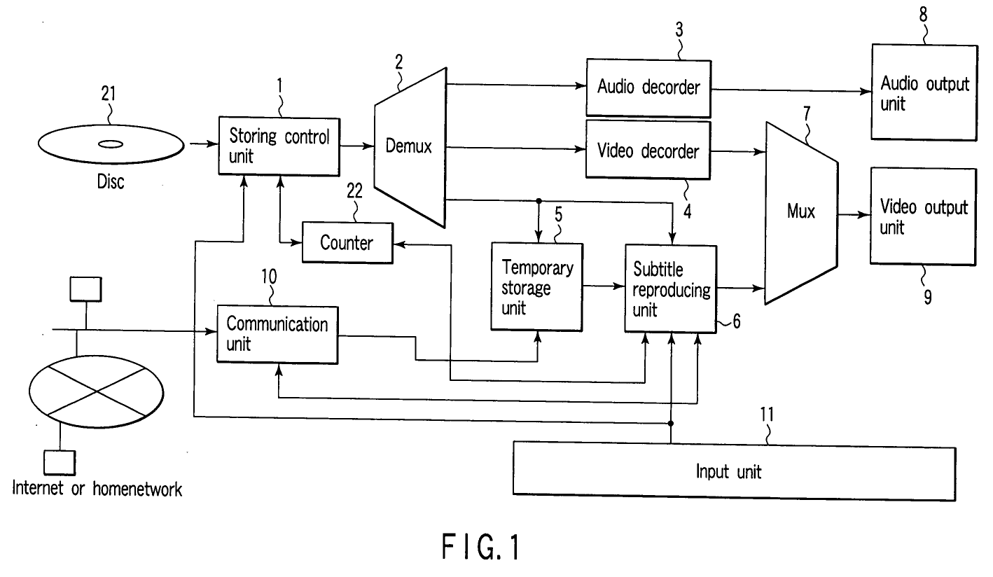

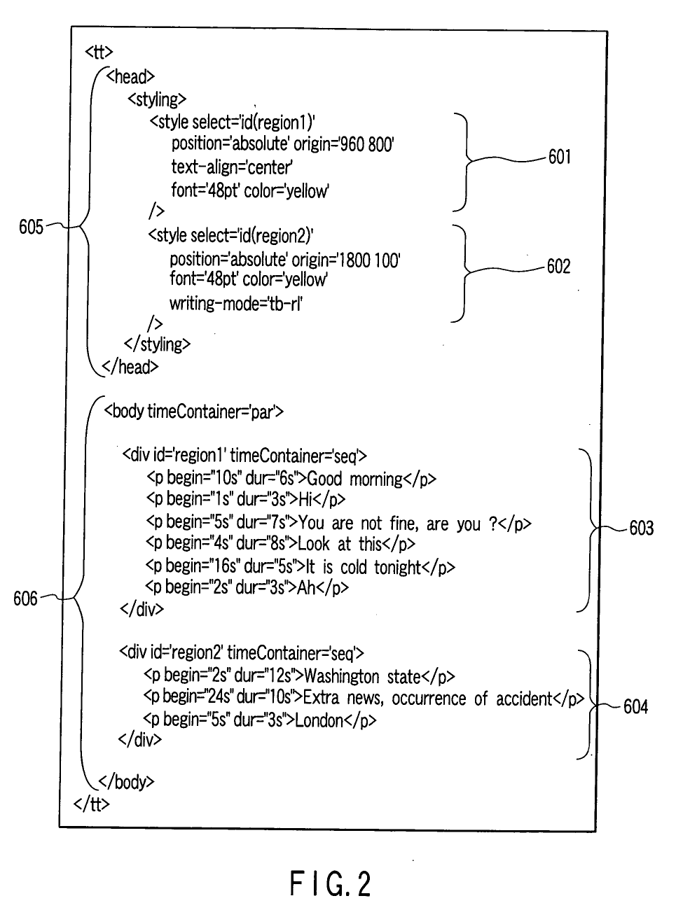

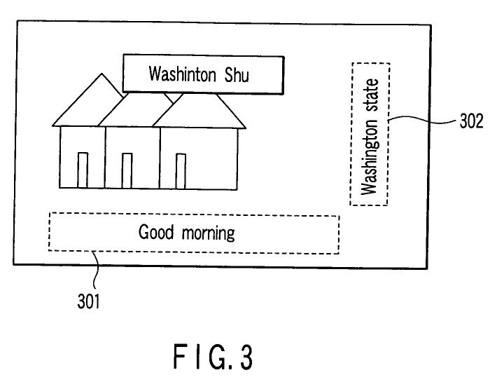

FIG. 2 shows one example of the XML document of the subtitle data. FIG. 3 shows a display example in a display screen in a case where video data recorded in the disk, and the subtitle data of the XML document of FIG. 2 are displayed in a predetermined display device connected to the content reproduction apparatus of FIG. 1. In the example of FIG. 3, subtitles are superimposed and displayed on two regions 301, 302 in a picture. Usually, a subtitle obtained by dubbing voice is displayed in the vicinity of the center of a lower side of the display device as in the region 301, but furthermore a signboard, sentence, and situation explanation in characters of another language displayed in the picture are sometimes separately displayed on the right side as in the region 302.

The XML document of FIG. 2 is an example in which the subtitles are displayed in a plurality of positions of a screen (picture). The timed text has a syntax similar to that of an HTML document, and basically includes a <head> element 605 and a <body> element 606.

The <head> element 605 includes rule definition of a style attribute to which a cascade style sheet (CSS) is applied. This example includes two style rule definitions 601, 602, and styles are defined for an element 603 displayed in the region 301 of FIG. 3 corresponding to “region 1” indicated as an ID attribute, and an element 604 displayed in the region 302 of FIG. 3 corresponding to “region 2” indicated as an ID attribute.

In the <head> element, as style information on the layout for displaying the subtitle in the screen for each subtitle display region (here, the regions 301, 302), there are included information on the display region of the subtitle, such as a size and a position of the subtitle display region and arrangement of the text, in addition to information on subtitle display forms, such as a character font type, size, and color.

In FIG. 2, the style rule definition 601 indicates that the <div> element 603 is displayed in the position 301 of FIG. 3, and the style rule definition 602 indicates that the <div> element 604 is displayed in the position 302 of FIG. 3.

In the <body> element 606, subtitle data to be displayed and the display timing are described. In a case where a value of timeContainer attribute of the <body> element is “par”, it is indicated that time of the <div> element as a sub-element of the <body> element advances in parallel. That is, in the example shown in FIG. 2, two subtitles: the <div> element 603; and the <div> element 604 are time-managed and displayed in parallel.

In the <div> elements 603, 604, “seq” is designated as the value of the timeContainer attribute. This indicates that <p> elements as sub-elements are successively displayed. The <p> element includes a subtitle text of one display unit, and a begin attribute and a dur attribute are designated. The begin attribute indicates a display start time (reproduction start time) indicating a time when the corresponding element is to be displayed (reproduced), and the dur attribute indicates a display time indicating for how many seconds the element is to be displayed. However, the time designated by the begin attribute of each element is a time from a time when the displaying of an element immediately before the corresponding element is completed until the displaying of the element starts (reproduction starts), that is, a relative time counted from the display completion time of the element immediately before the corresponding element, and the time is different from a reproduction time counted from a time when the reproduction of video or video (content data) in the disk starts.

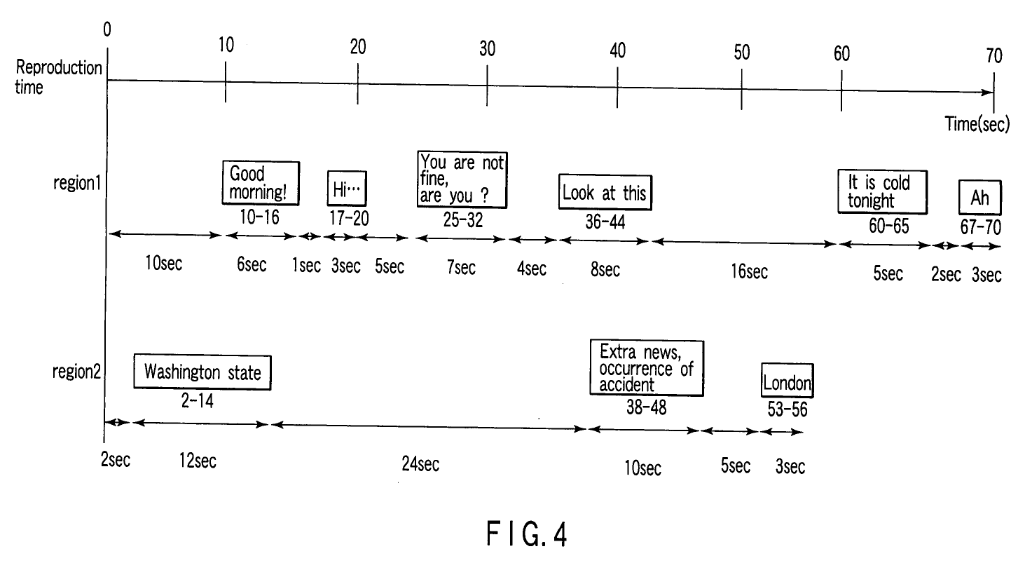

FIG. 4 is a diagram showing subtitle data described in the XML document of FIG. 2. The abscissa indicates the reproduction time of the video or video (content data) in the disk, and the ordinate indicates arranged subtitles to be displayed in the “region 1” and the “region 2” corresponding to two regions 301, 302 of FIG. 3, respectively. In FIG. 4, each subtitle text is surrounded with a rectangle, and the position and size of the rectangle indicate the text display (reproduction) start time, the display end time, and the display time of the subtitle. Numerals such as “17-20” disposed under the rectangle of each subtitle text indicate that this subtitle text is assigned (displayed) between a reproduction time of 17 seconds and that of 20 seconds.

In the “region 1”, as to the <p> element to be displayed first, it is assumed that begin=“10s”, dur=“6s”. Therefore, subtitle (text) “Good morning!” is assigned and displayed for six seconds from a reproduction time of ten seconds. As to the next <p> element, since begin=“1s” and dur=“3s”, subtitle “Hi . . . ” is assigned (displayed) for three seconds from a time when one second elapses from a reproduction time of 16 seconds that is the display end time of the previous subtitle “Good morning!”.

Similarly, in the “region 2”, subtitle “Washington state” is assigned (displayed) between a reproduction time of 2 seconds and that of 14 seconds, and “extra news, occurrence of accident” is assigned between a reproduction time of 38 seconds and that of 48 seconds.

(Constitution)

FIG. 1 shows a constitution example of a content reproduction apparatus to reproduce a recording medium such as an optical disk in which content data including video and voice data, subtitle data and the like are recorded. The device displays subtitle data recorded in the recording medium or subtitle data downloaded from a network while reproducing the content data in the recording medium.

In FIG. 1, in the content reproduction apparatus, when a disk is inserted, a storing control unit 1 reads various types of information (VOBU (described later), reproduction control information, etc.) from the corresponding disk. A separation unit (Demux) 2 separates audio data, video data, and divided subtitle XML data (segment data items) from VOBU (described later) read from the disk by the storing control unit 1, outputs the audio data to an audio decoder 3, outputs the video data to a video decoder 4, and outputs the divided subtitle XML data to a temporary storage unit 5. Information required for the reproduction of the subtitle, such as subtitle reproduction control information and common subtitle XML data read from the disk by the storing control unit 1, are output to a subtitle reproducing unit 6.

The audio decoder 3 decodes input audio data, and outputs the data to an audio output unit 8.

The video decoder 4 decodes the input video data, and outputs the data to a synthesis unit (Mux) 7.

A counter 22 counts the reproduction time, and starts counting the reproduction time when the reproduction of the disk is started (the storing control unit 1 starts reading the content data and the like from the disk).

The subtitle reproducing unit 6 generates display data (subtitle display data) for displaying the subtitle text by use of the subtitle reproduction control information, the common subtitle XML data, and the divided subtitle XML data stored in the temporary storage unit 5, and outputs the data to the synthesis unit (Mux) 7. It is to be noted that as described later, to acquire the subtitle reproduction control information, the common subtitle XML data, the divided subtitle XML data and the like from a server in a network, a communication unit 10 accesses the server to acquire desired data.

The synthesis unit 7 synthesizes subtitle display data on the video data decoded by the video decoder 4, and outputs the data to a video output unit 9.

An input unit 11 inputs instructions for the reproduction start and end of a disk 21 and the like with respect to the storing control unit 1, the subtitle reproducing unit 6, and the like.

In the present embodiment, there will be described: a method of dividing, into a plurality of documents, one XML document including the whole subtitle data (of one language among a plurality of languages) corresponding to the content data recorded in the disk to store the documents; and a method of preparing, from the divided partial documents only, the divided subtitle XML data which performs the same behavior within a time period designated while the content data is reproduced, and reproducing the subtitle.

(Data Construction and Storing Method in Disk)

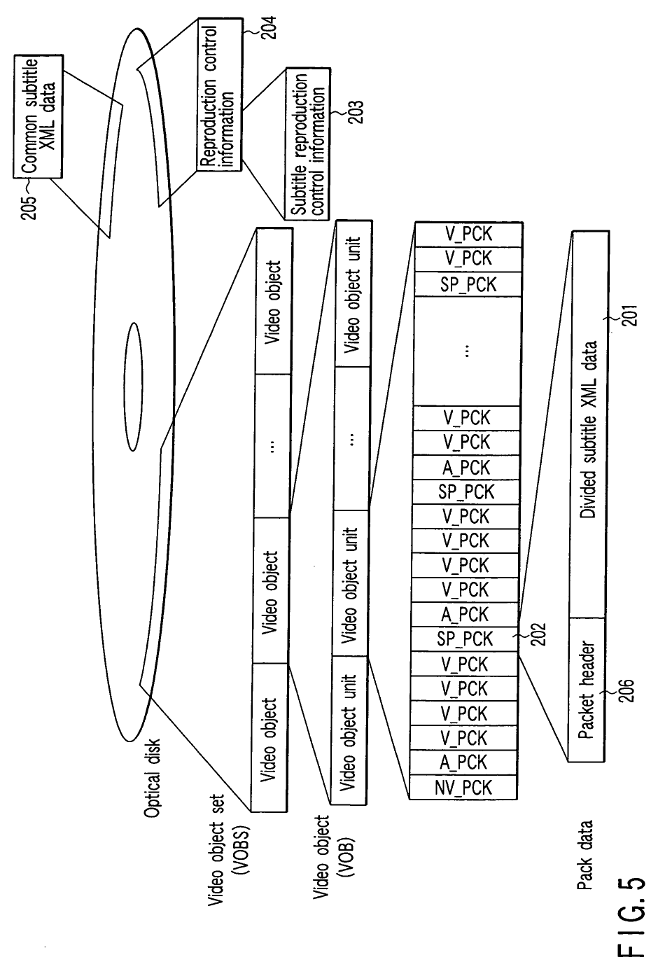

FIG. 5 shows one method to store divided subtitle XML data in a disk. For example, in DVD-video standard, video data, audio data, sub-picture as a bitmap subtitle, navigation information and the like are multiplexed and stored. That is, each medium data is divided by time, packed as pack information, multiplexed into a video object unit (VOBU) which is a 0.4 to one second unit, and stored. A video object is constituted of a row of VOBUs.

The present embodiment has a constitution similar to a constitution in which instead of the sub-picture, divided subtitle XML data 201 is stored in an SP_PACK 202 containing the sub-picture of the VOBU. It is to be noted that the data may be stored as a separate new pack, not as the SP_PACK.

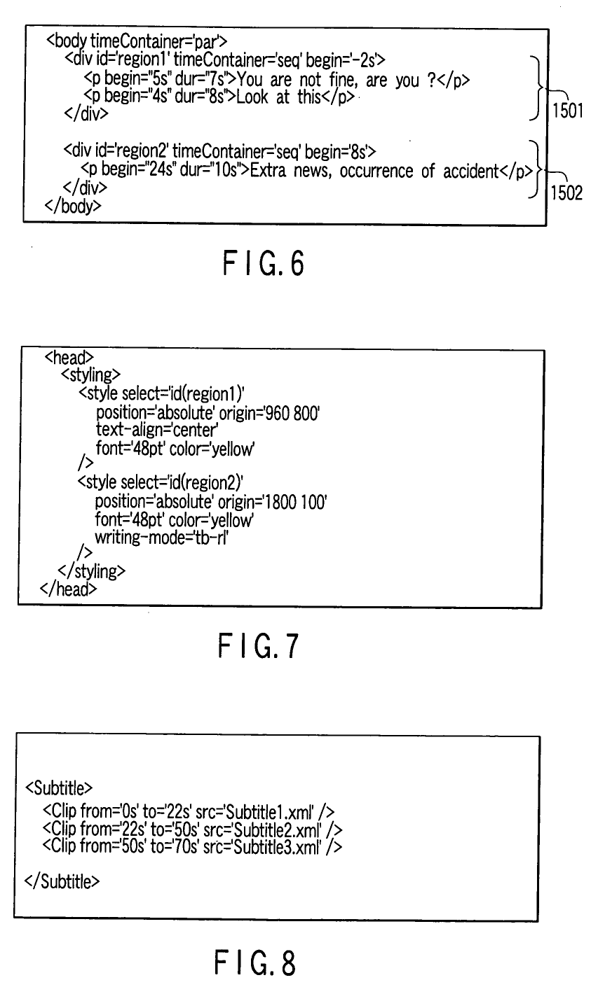

Header information (packet header) 206 is added to the divided subtitle XML data to constitute pack data. The header information includes a length of the pack data, class information indicating a class of information included in the pack data and the like. The divided subtitle XML data 201 includes subtitle texts displayed in a predetermined time period, the display timing, and time correction information. FIG. 6 shows a description example of divided XML data.

The divided subtitle XML data 201 is successively supplied from the disk to the subtitle information temporary storage unit 5 along with the reproduction of the video. Common subtitle XML data 205, and subtitle reproduction control information 203 which holds reproduction control information of the divided subtitle XML data are stored in another part of the disk. The common subtitle XML data 205 and the subtitle reproduction control information 203 are read at the time of the reproduction start of the disk, and they are combined with the divided subtitle XML data 201 during the reproduction, and used in subtitle reproduction. The common subtitle XML data 205 includes information of a <head> portion of an original XML document of subtitle data, a style rule definition (style sheet) and the like. FIG. 7 shows one example of the common subtitle XML data, and FIG. 8 shows one example of subtitle reproduction control information.

The subtitle reproduction control information 203 is stored together with a reproduction order of the video in reproduction control information 204 which controls the reproduction of the content data in the disk. It is to be noted that the subtitle reproduction control information 203 may be stored in a file which is different from that of the reproduction control information 204.

The common subtitle XML data itself may be read as a separate file during the reproduction start of the content data in the disk, or may be stored together with each divided subtitle XML data 201 in the same pack data as that of the divided subtitle XML data 201. In the common subtitle XML data, the style rule definition itself may be stored as the style sheet in the separate file, the style sheet only may be referred to in a <head> element, and the definition may be stored together with each divided subtitle XML data 201 in the same pack data as that of the divided subtitle XML data 201.

(Dividing Method of Subtitle Data along Time Axis, Divided Subtitle XML Data, and Subtitle Reproduction Control Information)

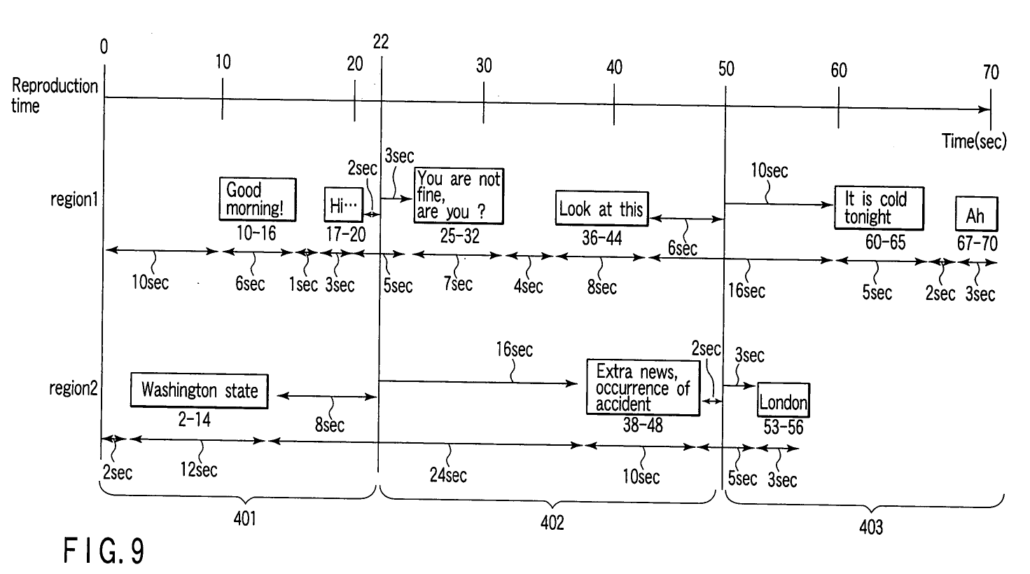

Here, there will be described a method of dividing, every time period, one XML document including the toal subtitle data corresponding to the content data recorded in the disk a shown in FIG. 2 with reference to FIGS. 4 and 9. Here, there will be described a case where the time axis of FIG. 5 is divided into three time periods.

The data is divided along the time axis based on a scene cut or the like, whereby segmenting the data in a place where no subtitle is displayed. That is, FIG. 9 shows a case where the time axis is divided into a time period 401 from a reproduction time of 0 seconds to 22 seconds, a time period 402 of 22 to 50 seconds, and a time period 403 of 50 to 70 seconds.

FIG. 8 shows the subtitle reproduction control information in a case where the time axis is divided as shown in FIG. 9. The subtitle reproduction control information shown in FIG. 8 indicates that the divided subtitle XML data having a file name “Subtitle1.xml” is reproduced in the time period of a reproduction time of 0 to 22 seconds, the divided subtitle XML data having a file name “Subtitle2.xml” is reproduced in the time period of a reproduction time of 22 to 50 seconds, and the divided subtitle XML data having a file name “Subtitle3.xml” is reproduced in the time period of a reproduction time of 50 to 70 seconds. For example, to reproduce the data from a reproduction time of 37 seconds, the reproduction may be executed from a position of the 15th second of “Subtitle2.xml”.

In the subtitle reproduction control information shown in FIG. 8, the file name of the divided subtitle XML data to be reproduced in each time period is referred to by means of a uniform resource identifier (URI), but the reference to the divided subtitle XML data in the pack data may be held beforehand in a directory, or map information to map the pack data in a name space of the directory may be separately held to refer to the file name. Alternatively, the pack data may be referred to directly from the subtitle reproduction control information by use of an identification number of the pack data or the like.

FIG. 6 shows the divided subtitle XML data corresponding to the time period 402 of FIG. 9. This divided subtitle XML data includes <div> elements corresponding to the respective display regions 301 (“region 1”), 302 (“region 2”) including <p> elements only of the corresponding time period among <body> elements of the original XML document, and time correction information (for each display region).

In the example of FIG. 6, the time correction information is included as a begin attribute which is not included in the original XML document, such as “begin=“−2s”” of <div> elements 1501, 1502 including the <p> elements of the subtitle texts corresponding to the display regions 301, 302 of FIG. 3.

As shown in FIG. 9, when the time axis is divided into a plurality of time periods, and the partial document corresponding to each time period is simply extracted from the XML document of the original subtitle data, the reproduction cannot be executed. For example, it is assumed that the reproduction of the <p> element including subtitle “you are not fine, are you?” starts five seconds after the completion of the display of the previous subtitle as indicated by begin=“5s” before the dividing. However, when the time axis is divided, the reproduction needs to be started three seconds after a start position of the divided subtitle XML data having the file name “Subtitle2.xml” corresponding to the time period of the reproduction time of 22 to 50 seconds. This time (e.g., −2 sec here) needs to be added and stored as a correction time.

For example, noting “region 1”, the time period 401 corresponding to the divided subtitle XML data having the name “Subtitle1.xml” ends two seconds after the display of the subtitle “Hi . . . ” ends. The first subtitle “You are not fine, are you?” is displayed five seconds after the display of the subtitle “Hi . . . ” ends in the time period 402 corresponding to the divided subtitle XML data having the name “Subtitle2.xml”. Therefore, when a start time of the divided subtitle XML data of “Subtitle2.xml” is shifted two seconds before, or when the reproduction of the subtitle “You are not fine, are you?” is started 5−2=3 seconds after the start of the time period 402, the subtitle “You are not fine, are you?” is displayed five seconds after the display of the subtitle “Hi . . . ” ends.

Such correction time (“−2 seconds” meaning that the reproduction start time of the first subtitle is shifted two seconds before in the time period in each display region) is represented by “begin =”−2s“ ” as the value of the begin attribute of the <div> element corresponding to “region 1” of “Subtitle2.xml”. It is to be noted that as to subtitle “Look at this.” after the subtitle “You are not fine, are you?” in “region 1”, since the display start time is represented by a relative time from the end of the previous subtitle, the time does not have to be corrected.

The correction time of the <div> element corresponding to “region 1” of the time period 402 can be obtained as “−2 seconds” by subtracting the reproduction time “22 seconds” corresponding to the start of the time period 402 from the reproduction time “20 seconds” indicating the display end time of the <p> element (subtitle “Hi . . . ”) which is the last sub-element of the <div> element corresponding to “region 1” of the time period 401 immediately before the time period 402.

More generally, the correction time of a certain <div> element of an n-th (n is an integer of 2 or more) time period can be obtained by subtracting the reproduction time corresponding to the start time of the n-th time period from the reproduction time indicating the display end time of the <p> element which is the last sub-element of the corresponding <div> element of a (n−1)-th time period immediately before the n-th time period.

This also applies to “region 2”. The time period 401 corresponding to the divided subtitle XML data titled “Subtitle1.xml” ends eight seconds after the display of the subtitle “Washington state” ends. Subtitle “extra news, occurrence of accident” to be first reproduced in the time period 402 corresponding to the divided subtitle XML data titled “Subtitle2.xml” is displayed 24 seconds after the display of the subtitle “Washington state” ends. Therefore, when the start time of the divided subtitle XML data “Subtitle2.xml” is shifted eight seconds before, or when the reproduction of the first subtitle “extra news, occurrence of accident” of the time period 402 is started 24−8=16 seconds after the start time of the time period 402, the subtitle “extra news, occurrence of accident” is displayed 24 seconds after the display of the subtitle “Washington state” ends. Such correction time (“−8 seconds” meaning that the reproduction start time of the first subtitle in the time period is shifted eight seconds before) is represented by “begin =“−8s”” as the value of the begin attribute of the <div> element corresponding to “region 2” of “Subtitle2.xml”.

The time correction information including the start time of the time period corresponding to the divided subtitle XML data or the correction time for correcting the reproduction start time of the first subtitle in the time period is added to each divided subtitle XML data for each display region as described above. Accordingly, even when the inside of the <body> element of the original XML document is divided by an arbitrary time period, each subtitle text in each partial document can be displayed in synchronization with the reproduction time of the content data.

Therefore, it is also easy to prepare the XML document of the whole subtitle data from the first to last content data, and divide the document into a plurality of partial documents depending on the file size.

(Generation of Reproducible Divided Subtitle XML Data Every Time Period from Divided Subtitle XML Data)

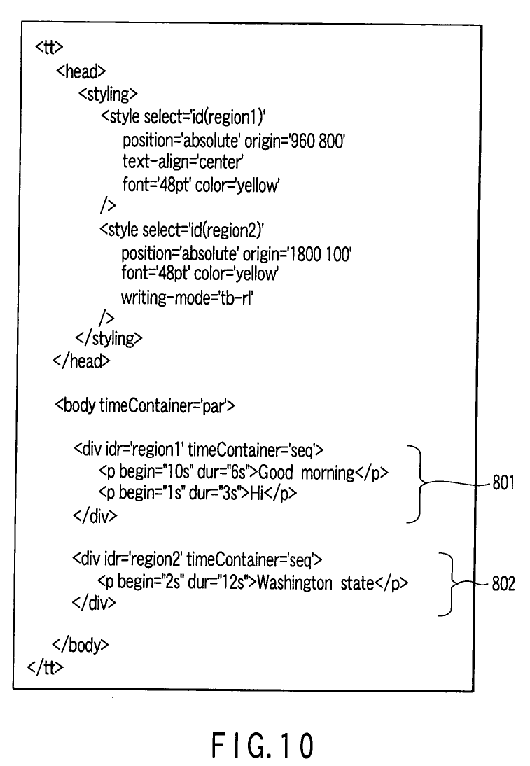

The divided subtitle XML data itself shown in FIG. 6 does not include any <head> element unlike the original XML document before the dividing. That is, the reproduction of the subtitle in the time period cannot be executed by means of the divided subtitle XML data only. Therefore, to reproduce each subtitle text of the divided subtitle XML data in each time period, as shown in FIGS. 10 to 12, there is required reproduction-executable (reproducible) divided subtitle XML data including the <head> element (common subtitle XML data) present in the original XML document.

FIGS. 10 to 12 show examples of the reproducible divided subtitle XML data every time period. The data is XML data which reproduces the only subtitles in the time periods of the time periods 401, 402, and 403 of FIG. 9.

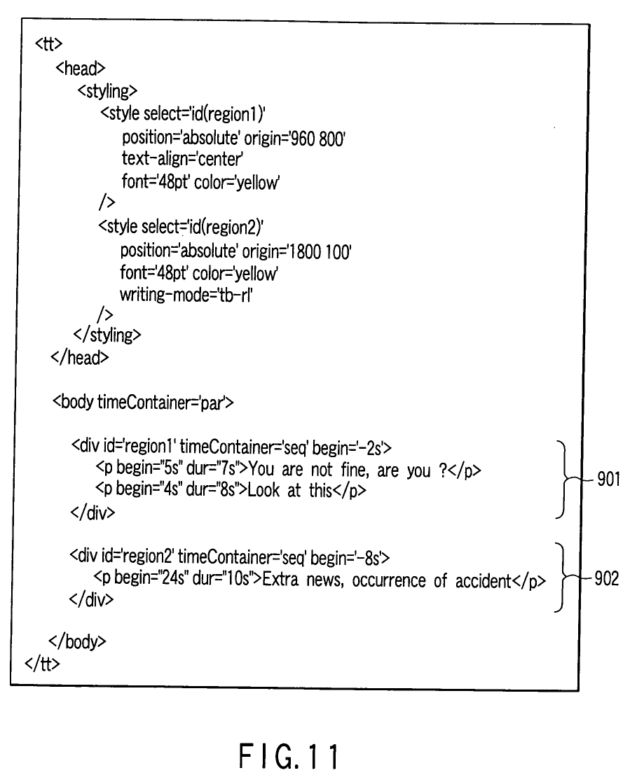

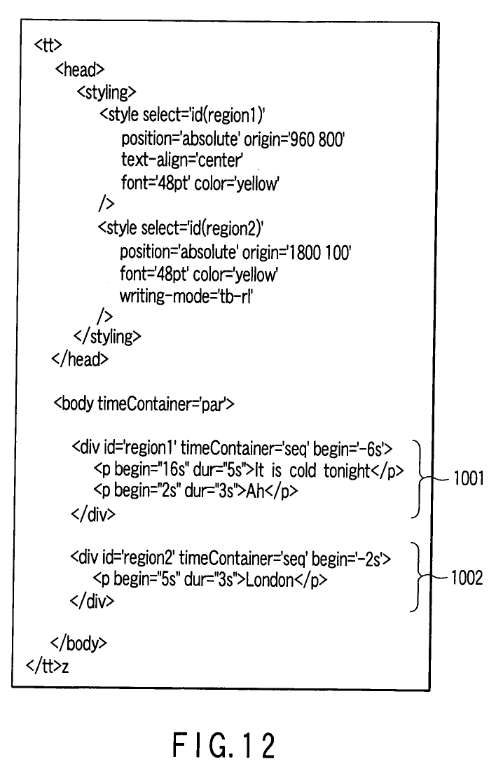

The data is described in a file form of a timed text form which can be reproduced from a reproduction time of 0 seconds in FIG. 10, a reproduction time of 22 seconds in FIG. 11, and a reproduction time of 50 seconds in FIG. 12, and subtitles in the respective time periods are described.

As described above, the reproducible divided subtitle XML data is obtained by removing the <p> elements of time periods other than the corresponding time period from the respective <div> elements in the <body> element of the original XML document before the dividing, and adding the time correction information (for each display region) to the remaining elements, that is, the <div> elements including the only <p> elements in the corresponding time period.

In the examples of FIGS. 10, 11, and 12, the correction time is shown as the value of the begin attribute which is not included in original subtitle XML data such as “begin=“−4”” of <div> elements 801, 802, 901, 902, 1001, and 1002 including the <p> elements of the subtitle texts corresponding to the display regions 301, 302 of FIG. 3.

FIG. 10 shows the reproducible divided subtitle XML data corresponding to the time period 401 of a reproduction time of 0 second to 22 seconds of FIG. 9. Since the reproduction starts from the reproduction time of 0 seconds, it is not necessary to correct the start time of the time period 401 for each display region or the reproduction start time of the first <p> element in the time period 401, and therefore “begin=“0s”” or the time correction information itself is not included in the data.

FIG. 11 shows the reproducible divided subtitle XML data corresponding to the time period 402 of a reproduction time of 22 to 50 seconds of FIG. 9. The <div> element 901 corresponding to “region 1” includes “begin=“−2s”” as the time correction information, and the start time of the time period 402 or the reproduction start time of the first <p> element in the time period 402 is corrected two seconds before in “region 1”.

Similarly, the <div> element 902 corresponding to “region 2” includes “begin=“−8s”” as the time correction information, and the start time of the time period 402 or the reproduction start time of the first <p> element in the time period 402 is corrected eight seconds before in “region 2”.

FIG. 12 shows the reproducible divided subtitle XML data corresponding to the time period 403 from a reproduction time of 50 seconds of FIG. 9. The <div> element 1001 corresponding to “region 1” includes “begin=“−6s”” as the time correction information, and the start time of the time period 403 or the reproduction start time of the first <p> element in the time period 403 is corrected six seconds before in “region 1”.

Similarly, the <div> element 1002 corresponding to “region 2” includes “begin=“−2s”” as the time correction information, and the start time of the time period 403 or the reproduction start time of the first <p> element in the time period 403 is corrected two seconds before in “region 2”.

The reproducible divided subtitle XML data shown in FIGS. 10 to 12 are reproduced as timed text files at the start time of each time period indicated by the subtitle reproduction control information in the subtitle reproducing unit 6 of FIG. 1. In this case, for each display region, the start time of each time period or the reproduction start time of the subtitle text first displayed in each time period is corrected by means of the correction time of each display region, so that the subtitle in the corresponding time period can be reproduced.

(Procedure for Generating Common Subtitle XML Data and Divided Subtitle XML Data)

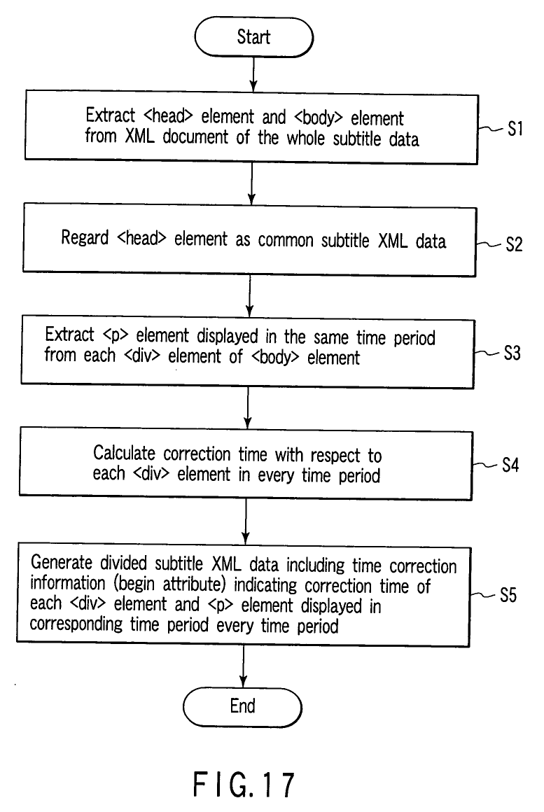

The reproducible divided subtitle XML data shown in FIGS. 10 to 12 may be used as the divided subtitle XML data 201, but header information (<head> element) is redundant. This information as the common subtitle XML data 205 may be stored and divided separately from the divided subtitle XML data 201 as shown in FIG. 5. Here, there will be described a procedure for generating, from the XML document including the whole subtitle data shown in FIG. 2, the common subtitle XML data of the only <head> element shown in FIG. 6 and the divided subtitle XML data which does not include any <head element> as shown in FIG. 8, with reference to a flowchart of FIG. 17.

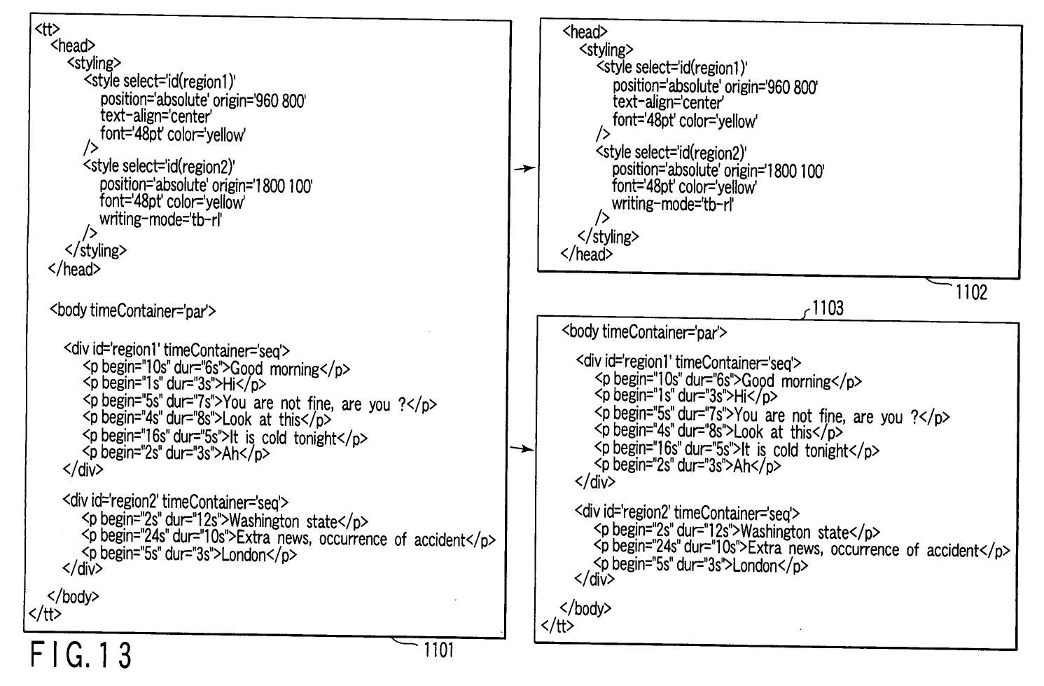

First, as shown in FIG. 13, a <head> element 1102 and a <body> element 1103 are extracted from an XML document 1101 including the whole subtitle data (step S1), and the <head> element 1102 is regarded as the common subtitle XML data (step S2).

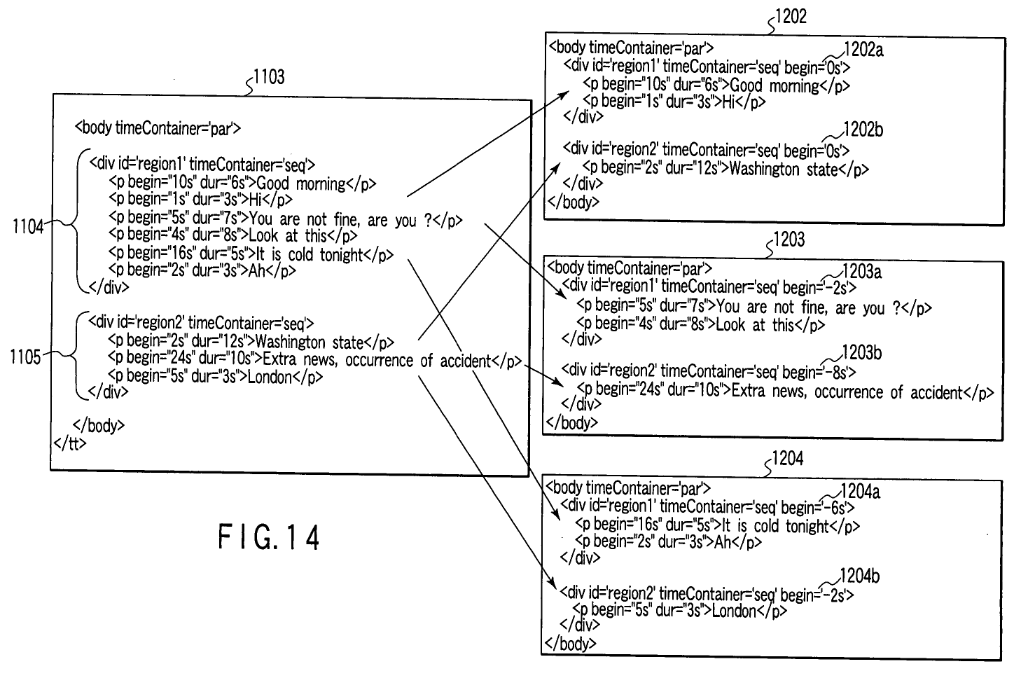

Next, the <p> element displayed in the corresponding time period is extracted every time period from each <div> element of the extracted <body> element 1103 (step S3), and the correction time is calculated as described above with respect to each <div> element in each time period (step S4). Moreover, as shown in FIG. 14, with respect to each time period, the divided subtitle XML data is generated which includes time correction information (begin attribute) indicating the correction time of each <div> element and the <p> element displayed within the corresponding time period (step S5).

FIG. 14 shows a case where three divided subtitle XML data 1202 to 1204 corresponding to three time periods 401 to 403, respectively, shown in FIG. 9 are generated from the <body> element 1103.

The respective divided subtitle XML data 1202 to 1204 include the <p> elements including the subtitle texts displayed in the same time period, which are extracted from <div> elements 1104, 1105 in the <body> element 1103 corresponding to the display regions 301, 302 of FIG. 3, respectively, and time correction information (begin attributes) 1202a, 1202b, 1203a, 1203b, 1204a, and 1204b including correction times calculated (for each display region) with respect to the <div> elements in the corresponding time period.

Here, there will be described in more detail a procedure to generate, from the <body> element 1103, three divided subtitle XML data 1202 to 1204 corresponding to three time periods, respectively, as shown in FIG. 9. First, the display start time and the display time included in each <p> element of the <body> element 1103 are developed along a reproduction time of video or voice (content data) in the disk as shown in FIG. 4. In addition, each <p> element within the corresponding time period is copied from the <body> element 1103 for each display region (“region 1”. “region 2”) with respect to the respective time periods 401 to 403 as shown in FIG. 9. Furthermore, the correction time is calculated for each display region, and added as the time correction information, whereby generating the divided subtitle XML data. This divided subtitle XML data is stored in the SP_PACK 202.

(Method of Converting Divided Subtitle XML Data into Reproducible Divided Subtitle XML Data)

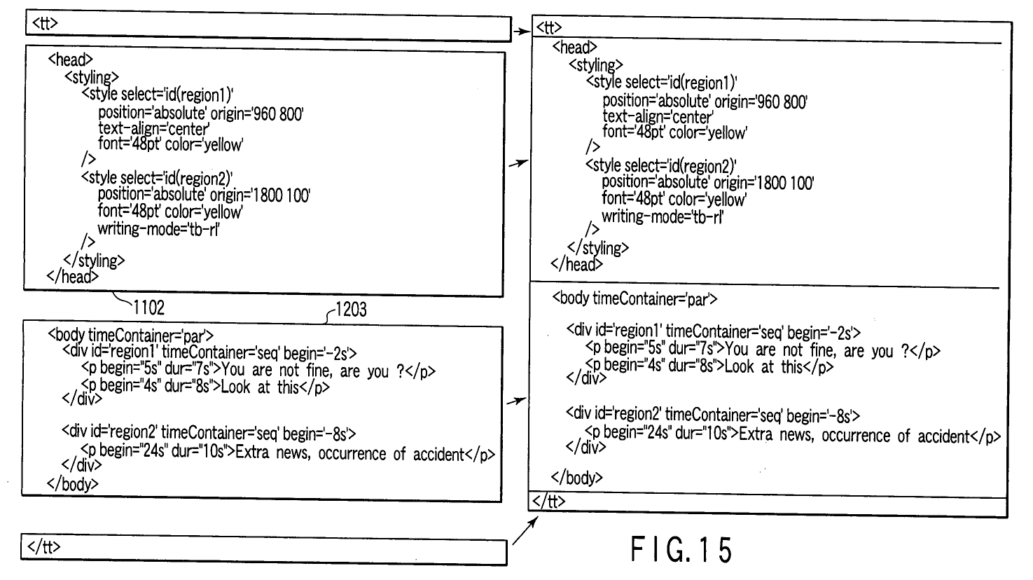

As described above, the subtitle cannot be reproduced every time period by means of the only divided subtitle XML data 1202 to 1204 of FIG. 14. Therefore, next, there will be described a method of converting the divided subtitle XML data 1202 to 1204 of FIG. 14 into the reproducible divided subtitle XML data (method of generating the reproducible divided subtitle XML data from the divided subtitle XML data) with reference to FIG. 15.

Here, there will be described a case where the divided subtitle XML data 1203 of FIG. 14 is converted into the reproducible divided subtitle XML data.

The common subtitle XML data 1102 is connected before the divided subtitle XML data 1203. The resultant connected XML fragment is surrounded with a start tag <tt> and an end tag </tt>, whereby obtaining the reproducible divided subtitle XML data corresponding to the time period 402 of FIG. 9.

(Reproduction Procedure of Subtitle in Disk)

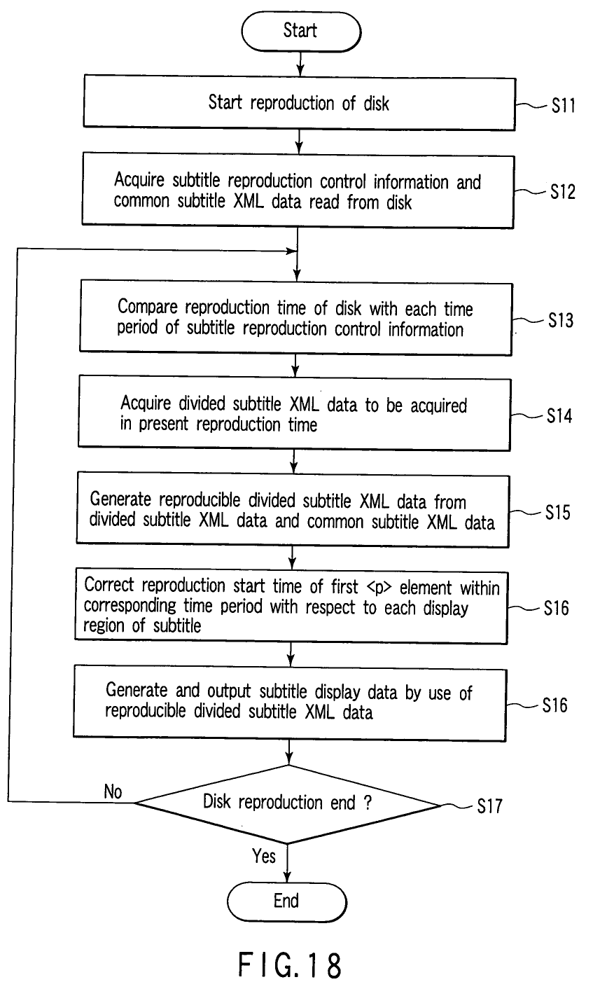

There will be described a procedure to reproduce the subtitle by the subtitle reproducing unit 6 in a case where the subtitle reproduction control information 203, the common subtitle XML data 205, and the divided subtitle XML data 201 multiplexed with the video or audio data are stored in the disk, with respect to a flowchart shown in FIG. 18.

When the disk is inserted into the content reproduction apparatus to start the reproduction of the disk (step S11), the counter 22 starts counting the reproduction time. The storing control unit 1 reads the subtitle reproduction control information and the common subtitle XML data together with the reproduction control information from the disk during the reproduction start of the disk or the title, and they are transferred to the subtitle reproducing unit 6 via the separation unit (Demux) 2 (step S12).

The VOB data in the optical disk is read by the storing control unit 1 during the reproduction, and the Demux 2 separates the video data, the audio data, and the divided subtitle XML data. The divided subtitle XML data is stored in the temporary storage unit 5.

The temporary storage unit 5 compares each time period in the subtitle reproduction control information with a value (reproduction time of the disk) of the counter 22 (step S13), and acquires the divided subtitle XML data corresponding to the present reproduction time or to be acquired at the present reproduction time (step S14). In this case, when new divided subtitle XML data is required, it is checked whether or not the divided subtitle XML data is present in the temporary storage unit 5. If there is not the data, the processing waits until the divided subtitle XML data arrives.

When the divided subtitle XML data corresponding to the present reproduction time or to be acquired at the present reproduction time is stored in the temporary storage unit 5, the data is acquired, and the reproducible divided subtitle XML data is generated from the divided subtitle XML data and the common subtitle data (step S15).

The subtitle reproducing unit 6 corrects the reproduction start time of the first subtitle text by use of the time correction information, when the first subtitle text (<p> element) is reproduced within the time period corresponding to the reproducible divided subtitle XML data in each display region for displaying the subtitle (step S16). That is, a time is calculated from the start time of the corresponding time period to the reproduction start time of the first subtitle text. For example, as shown in FIG. 9, in a case where each subtitle text is reproduced in the divided subtitle XML data corresponding to the time period 402, when the first subtitle text “You are not fine, are you?” in the time period 402 is reproduced in “Region 1”, begin=“5s” is included as the attribute information in the <p> element of the subtitle text, and “−2s” is included as the time correction information of “Region 1” of the divided subtitle XML data. Therefore, the reproduction start time of the first subtitle text “You are not fine, are you?” in the time period 402 is calculated as 5−2=3 seconds after the start time of the time period 402. When the first subtitle text “extra news, occurrence of accident” in the time period 402 is reproduced in “Region 2”, begin=“24s” is included as the attribute information in the <p> element of the subtitle text, and “−8s” is included as the time correction information of “Region 2” of the divided subtitle data. Therefore, the reproduction start time of the first subtitle text “extra news, occurrence of accident” in the time period 402 is calculated as 24−8=16 seconds after the start time of the time period 402.

The subtitle reproducing unit 6 reproduces each subtitle text within the time period corresponding to the reproducible divided subtitle XML data by use of the reproducible divided subtitle XML data (step S17). First, to reproduce the first subtitle text within the time period in each display region for displaying the subtitle text, the reproduction of the first subtitle text is started at the time obtained in the step S16 after the start time of the time period, and the subtitle display data for displaying the first subtitle text is generated, and output to the synthesis unit (Mux) 7. To reproduce second and subsequent subtitle texts, when the time included as the begin attribute of the <p> element in the second and subsequent subtitle texts elapses from the display end time of the immediately previous subtitle text, the reproduction of the second and subsequent subtitle texts is started, and the subtitle display data for displaying the second and subsequent subtitle texts is generated, and output to the synthesis unit (Mux) 7.

The subtitle display data for displaying each subtitle text displays the subtitle text in the display form (character font type, size, color, etc.) designated by the <head> element in the display region (display position) of the subtitle designated by the <head> element included in the reproducible divided subtitle data in a display screen in which the content (video) is displayed.

The Mux 7 synthesizes the input subtitle display data on the video data separated by the Demux 2 and decoded by the video decoder 4, and outputs the data to the video output unit 9. The synthesized video data of the subtitle display data output from the video output unit 9 is sent and displayed in a display device.

The execution processing of the reproducible divided subtitle XML data in the subtitle reproducing unit 6 is performed from the time period of the divided subtitle XML data described in the subtitle reproduction control information until the reproduction display of all of the <p> elements ends. When the display time of the last <p> element in the time period ends, the processing waits until the next new divided subtitle XML data reaches the temporary storage unit 5.

The processing of the steps S13 to S17 is repeated until an instruction for ending the reproduction of the disk is input (step S18).

(Reproduction Procedure of the Subtitle in a Case Where the Divided Subtitle XML Data is Downloaded and Acquired from the Network)

The case where the subtitle data is stored in the disk has been described above. Next, there will be described a case where the subtitle data is stored in a server on a network, and successively supplied therefrom, with reference to FIG. 18. In this case, the subtitle is reproduced in the same manner as in a case where all the subtitle data is present in the above-described disk, except that all of the subtitle reproduction control information, the common subtitle XML data, and a plurality of divided subtitle XML data, or a part of them exist in the server and that processing is performed to request them from the server and download and acquire them if necessary during the disk reproduction. This case is different from the case where the subtitle reproduction control information, the common subtitle XML data, and the plurality of divided subtitle XML data are all stored in the disk in the processing operation of the steps S12 and S14 of FIG. 18.

All of the subtitle reproduction control information, the common subtitle XML data, and the plurality of divided subtitle XML data may be held in the server on the network, or a part of them may be held in the server on the network whereas the remaining information/data may be stored in the disk.

Moreover, address information such as the uniform resource locator (URL) indicating the server of a destination is included in at least one of the subtitle reproduction control information, the common subtitle XML data (<head> element), the respective divided subtitle XML data, and the <head> element in a case where the <head> element is included in each divided subtitle XML data. Alternatively, the information may be stored beforehand in a predetermined specific region in the disk. Furthermore, the server corresponding to the address information stored in the specific region may notify the address information of the server capable of acquiring all or a part of the subtitle reproduction control information, the common subtitle XML data, and the plurality of divided subtitle XML data. The content reproduction apparatus accesses the server to acquire desired information by use of, for example, the address information read from the disk or acquired from the network.

In a case where the reproduction of the disk is started (step S11), when the subtitle reproduction control information and the common subtitle XML data are stored in the disk, the subtitle reproducing unit 6 of the content reproduction apparatus acquires the subtitle reproduction control information and the common subtitle XML data read from the disk as described above (step S12). On the other hand, when the subtitle reproduction control information and the common subtitle XML data exist in the server on the network, not in the disk, the subtitle reproduction control information and the common subtitle XML data are acquired from the server by use of the communication unit 10 (step S12).

The temporary storage unit 5 compares each time period in the subtitle reproduction control information with the value (disk reproduction time) of the counter 22 (step S13), and acquires the divided subtitle XML data corresponding to the present reproduction time or to be acquired in the present reproduction time (step S14). In this case, when the divided subtitle XML data corresponding to the present reproduction time or to be acquired in the present reproduction time exists in the server, the divided subtitle XML data is acquired from the server by use of the communication unit 10 (step S14).

That is, in the step S14, on receiving the divided subtitle XML data from the server, the communication unit 10 stores it in the temporary storage unit 5, and notifies it to the subtitle reproducing unit 6. When the subtitle reproducing unit 6 reads, from the temporary storage unit 5, the divided subtitle XML data corresponding to the present reproduction time or to be acquired in the present reproduction time, the unit generates the reproducible divided subtitle XML data from the divided subtitle XML data and the common subtitle data (step S15).

Moreover, after the subtitle reproducing unit 6 corrects the reproduction start time of the first subtitle text within the time period corresponding to the reproducible divided subtitle XML data by use of the time correction information in each display region for displaying the subtitle text (step S16), the unit reproduces each subtitle text within the time period corresponding to the reproducible divided subtitle XML data by use of the reproducible divided subtitle XML data as described above (step S17). That is, the reproduction of the subtitle text is started at the reproduction start time of each subtitle text, and the subtitle display data for displaying each subtitle text is generated, and output to the synthesis unit (Mux) 7.

As described above, the processing operation other than that of the steps S12 and S14 of FIG. 18 is the same as that in a case where the subtitle reproduction control information, the common subtitle XML data, and the plurality of divided subtitle XML data are all stored in the disk.

It is to be noted that it is more preferable to request the server for the divided subtitle XML data corresponding to the time period beforehand at a predetermined reproduction time before entering the time period in a case where the server is requested to download the divided subtitle XML data corresponding to the time period from the server. In this case, the divided subtitle XML data corresponding to each time period is requested from the server, or the time (prefetch time) to acquire the data from the server is described beforehand in the subtitle reproduction control information or the reproduction control information.

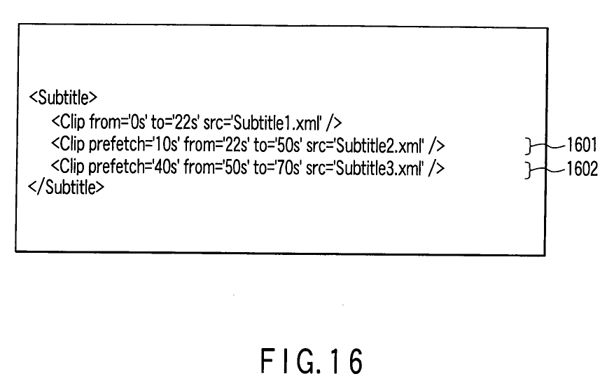

FIG. 16 shows a case where the subtitle reproduction control information indicating each time period (start time and end time of the time period) and the file of the divided subtitle XML data corresponding to the time period includes the prefetch time which is the time to request the divided subtitle XML data corresponding to the time period from the server or acquire the data from the server with respect to each time period. In FIG. 16, the prefetch time is indicated by a prefetch attribute of a <Clip> element corresponding to each time period.

A <Clip> element 1601 of FIG. 16 corresponding to the time period 402 of FIG. 9 indicates that the divided subtitle XML data corresponding to the time period is requested to the server or acquired from the server from a reproduction time of “10 seconds”. That is, since the divided subtitle XML data corresponds to the time period from a reproduction time of 22 seconds to a reproduction time of 50 seconds, the <Clip> element 1601 indicates that the downloading of the divided subtitle XML data be requested of the server or the data be acquired from the server in a case where any request for the divided subtitle XML data is not made to the server, and the divided subtitle XML data is not stored in the temporary storage unit 5 between a reproduction time of ten seconds that is ten seconds before the start time of this time period and a reproduction time of 50 seconds. Therefore, in the step S14 of FIG. 18, the subtitle reproducing unit 6 requests the server to download the divided subtitle XML data, and acquires the divided subtitle XML data in a case where the divided subtitle XML data is not stored in the temporary storage unit 5 at the reproduction time of ten seconds.

Similarly, a <Clip> element 1602 corresponding to the time period 403 of FIG. 9 indicates that the divided subtitle XML data corresponding to the time period is requested from the server from a reproduction time of 20 seconds. That is, since the divided subtitle XML data corresponds to the time period from a reproduction time of 50 seconds to a reproduction time of 70 seconds, the <Clip> element 1602 indicates that the downloading of the divided subtitle XML data be requested to the server or the data be acquired from the server in a case where no request for the divided subtitle XML data is made to the server, and the divided subtitle XML data is not stored in the temporary storage unit 5 between a reproduction time of 40 seconds that is ten seconds before the start time of this time period and a reproduction time of 70 seconds.

Therefore, in the step S14 of FIG. 18, the subtitle reproducing unit 6 requests the server to download the divided subtitle XML data, and acquires the divided subtitle XML data in a case where the divided subtitle XML data is not stored in the temporary storage unit 5 at the reproduction time of 40 seconds.

As described above, the divided subtitle XML data corresponding to the time period is requested and acquired (prefetched) from the server at a time which is a predetermined time before the start time of each time period. Accordingly, it can be expected that the subtitle of the time period is displayed every time period without being influenced by a delay time of a communication time which largely fluctuates owing to the degree of congestion in communication.

As described above, according to the present embodiment, in a case where the content data is reproduced from the recording medium which stores the content data including the video data and the audio data (by reproduction means including the audio decoder 3, the video decoder 4 and the like), the divided subtitle XML data including the subtitle text to be reproduced within the time period is acquired from the recording medium or via the network every time period of the content data to be reproduced, and each subtitle text within the time period of the content data is reproduced by use of the acquired divided subtitle XML data.

Moreover, the recording medium further stores the subtitle reproduction control information indicating each time period of the content data and the divided subtitle XML data corresponding to each time period, and the subtitle reproducing unit 6 acquires the divided subtitle XML data corresponding to the time period of the content data to be reproduced from the recording medium or via the network based on the subtitle reproduction control information read from the recording medium.

In a case where the language (Japanese, English or the like) is input via the input unit 11, and the divided subtitle XML data is acquired from the recording medium or via the network before starting the reproduction of the content data in the recording medium, in the step S14 and the step S12) of FIG. 18, the divided subtitle XML data (and the subtitle reproduction control information) of the input language is acquired.

Moreover, to reproduce each subtitle text within the time period of the content data, the subtitle reproducing unit 6 generates the reproducible divided subtitle XML data from the common subtitle XML data acquired from the recording medium or via the network and required for reproducing the divided subtitle XML data, and the divided subtitle XML data corresponding to the time period. The unit reproduces each subtitle text within the time period by use of the reproducible divided subtitle XML data.

The divided subtitle XML data acquired from the recording medium or via the network includes each subtitle text (<p> element) to be reproduced within the time period every time period obtained by dividing the reproduction time of the content data as shown, for example, in FIG. 6, but as shown in FIGS. 10 to 12, there is further a case where the <head> element including information on subtitle display region or form is included. In the reproduction procedure of the subtitle in the former case, as described already with reference to FIG. 18, in the step S15, it is necessary to generate the reproducible divided subtitle XML data by use of the common subtitle XML data. However, in the latter case, since the divided subtitle XML data is divided subtitle XML data being reproducible as such, the step S15 is skipped. The reminder of the subtitle reproduction procedure is similar to that of the former case.

Each subtitle text included in the divided subtitle XML data includes the attribute information which indicates the reproduction start time of the subtitle text by means of the time from the display end time of the immediately previous subtitle text to the reproduction start time. The divided subtitle XML data includes the time correction information for correcting the reproduction start time of the first subtitle text in the time period corresponding to the divided subtitle XML data every display region for displaying the subtitle. To reproduce the first subtitle text within the time period of the content data to be reproduced in each display region for displaying the subtitle text, the subtitle reproducing unit 6 starts the reproduction of the first subtitle text at the reproduction start time corrected using the attribute information and the time correction information of the first subtitle text. To reproduce the second and subsequent subtitle texts, the unit starts the reproduction of the second and subsequent subtitle texts when the time indicated by the attribute information of the second and subsequent subtitle texts elapses from the display end time of the immediately previous subtitle text.

According to such constitution, in a case where many language subtitle data (described in XML such as the timed text) are prepared for the content data in a recording medium such as the optical disk, the subtitle of the desired language corresponding to the presently reproduced content data can be easily reproduced and displayed simultaneously with the reproducing of the content data in the recording medium. The embodiment is applicable to a random access in a case where the processing jumps from a reproduction position of the disk at the present time to another reproduction position to reproduce the content data.

Moreover, in a case where the subtitle data is downloaded from the network, the subtitle can be easily reproduced in synchronization with the reproduction of the content data in the recording medium.

The technology of the present invention described in the embodiment of the present invention may be stored and distributed as a program executable by a computer in a recording medium such as a magnetic disk (flexible disk, hard disk or the like), an optical disk (CD-ROM, DVD or the like), or a semiconductor memory.

For example, when a computer provided with storage means such as the temporary storage unit 5, the communication unit 10 and the like executes a program for realizing functions of reproduction means (the audio decoder 3, the video decoder 4, etc.) for reproducing the content data stored in the recording medium to store the content data including the video or audio data and program, and the subtitle reproducing unit 6, the content reproduction apparatus of FIG. 1 can be realized.

Moreover, in the above-described embodiment, the case where the subtitle data is described in XML has been described, but the present invention is not limited to this case, and the present invention is similarly applicable to a case where the data is described in another structured document description language.

The present invention is applied to a content reproduction apparatus which reproduces and executes content data including video/audio information and a program recorded on a recording medium such as an optical disk.

What is claimed is:

1. A content reproduction apparatus comprising:
a content reproduction unit configured to reproduce a content data item from a recording medium, the recording medium storing the content data item and a plurality of segment data items which are described in a structured document description language, the segment data items corresponding, respectively, to a plurality of time periods which are segments of a reproduction time period required for reproducing whole of the content data item, and each of the segment data items, which corresponds to each of the time periods, including a group of subtitle data items to be reproduced within the each of the time periods; and
a subtitle reproduction unit configured to reproduce the group included in the each of the segment data items while a partial content data part which is to be reproduced within the each of the time periods is reproduced by the content reproduction unit.

2. The content reproduction apparatus according to claim 1, wherein the recording medium further stores a subtitle reproduction control information item representing the time periods and the segment data items corresponding to them, respectively, and
the subtitle reproduction unit reproduces the group which is included in the each of the segment data items and is selected in reference to the subtitle reproduction control information item.

3. The content reproduction apparatus according to claim 1, wherein each subtitle data item of the subtitle data items of the group included in each of the segment data items includes an attribute data item representing a reproduction start time of the each subtitle data item,
the reproduction start time of one subtitle data item of the subtitle data items which is reproduced and displayed first, the reproduction start time corresponding to a time from a display ending time point of a subtitle data item displayed immediately before reproduction of the one subtitle data item to a starting time point of reproducing the one subtitle data item,
the reproduction start time of another subtitle data item of the subtitle data items which is reproduced and displayed next to the one subtitle data item, the reproduction start time corresponding to a time from a display ending time point of the one subtitle data item to a starting time point of reproducing the another subtitle data item,
each of the segment data items includes a time correction data item for use in correcting the reproduction start time of the one subtitle data item,
the subtitle reproduction unit starts reproducing the one subtitle data item when a corrected reproduction start time elapses from a starting time point of each of the time periods, the corrected reproduction start time being obtained by correcting the reproduction start time of the one subtitle data item by using the time correction data item, and
the subtitle reproduction unit starts reproducing the another subtitle data item, when the reproduction start time of the another subtitle data items elapses from the display ending time point of the one subtitle data item.

4. The content reproduction apparatus according to claim 3, wherein the corrected reproduction start time corresponds to a time from the starting time point of each of the time periods to the starting time point of reproducing the one subtitle data item.

5. The content reproduction apparatus according to claim 1, wherein the recording medium further stores a common subtitle data item which is necessary for the subtitle reproduction unit to reproduce the group and includes a style information item indicating a subtitle display region and a display form of each of the subtitle data items of the group, and
the subtitle reproduction unit generates a reproducible segment data item from each of the segment data items and the common subtitle data item, and displays the group on the subtitle display region in the display form based on the reproducible segment data item.

6. A content reproduction apparatus comprising:
a content reproduction unit configured to reproduce a content data item from a recording medium, the recording medium storing the content data item;
an acquiring unit configured to acquire, via a network, a plurality of segment data items which are described in a structured document description language, the segment data items corresponding, respectively, to a plurality of time periods which are segments of a reproduction time period required for reproducing whole of the content data item, and each of the segment data items, which corresponds to each of the time periods, including a group of subtitle data items to be reproduced within the each of the time periods; and
a subtitle reproduction unit configured to reproduce the group included in the each of the segment data items while a partial content data part which is to be reproduced within the each of the time periods is reproduced by the content reproduction unit.

7. The content reproduction apparatus according to claim 6, wherein the recording medium further stores a subtitle reproduction control information item representing the time periods and the segment data items corresponding to them, respectively, and
the acquiring unit acquires the each of the segment data items which is selected in reference to the subtitle reproduction control information item.

8. The content reproduction apparatus according to claim 6, wherein each subtitle data item of the subtitle data items of the group included in each of the segment data items includes an attribute data item representing a reproduction start time of the each subtitle data item,
the reproduction start time of one subtitle data item of the subtitle data items which is reproduced and displayed first, the reproduction start time corresponding to a time from a display ending time point of a subtitle data item displayed immediately before reproduction of the one subtitle data item to a starting time point of reproducing the one subtitle data item,
the reproduction start time of another subtitle data item of the subtitle data items which is reproduced and displayed next to the one subtitle data item, the reproduction start time corresponding to a time from a display ending time point of the one subtitle data item to a starting time point of reproducing the another subtitle data item,
each of the segment data items includes a time correction data item for use in correcting the reproduction start time of the one subtitle data item,
the subtitle reproduction unit starts reproducing the one subtitle data item when a corrected reproduction start time elapses from a starting time point of each of the time periods, the corrected reproduction start time being obtained by correcting the reproduction start time of the one subtitle data item by using the time correction data item, and
the subtitle reproduction unit starts reproducing the another subtitle data item, when the reproduction start time of the another subtitle data items elapses from the display ending time point of the one subtitle data item.

9. The content reproduction apparatus according to claim 8, wherein the corrected reproduction start time corresponds to a time from the starting time point of the each of the time periods to the starting time point of reproducing the one subtitle data item.

10. The content reproduction apparatus according to claim 6, wherein the recording medium further stores a common subtitle data item which is necessary for the subtitle reproduction unit to reproduce the group and includes a style information item indicating a subtitle display region and a display form of each of the subtitle data items of the group, and
the subtitle reproduction unit generates a reproducible segment data item from each of the segment data items and the common subtitle data item, and displays the group on the subtitle display region in the display form based on the reproducible segment data item.

11. The content reproduction apparatus according to claim 7, wherein the subtitle reproduction control information item further includes an acquiring time corresponding to a time from a starting time point of reproducing the content data item to a time point at which the each of the segment data items is to be acquired via the network, and
the acquiring unit acquires the each of the segment data items via the network when the acquiring time elapses from the starting time point of reproducing the content data item.

12. The content reproduction apparatus according to claim 6, wherein the acquiring unit further acquires, via the network, a common subtitle data item which is necessary for the subtitle reproduction unit to reproduce the group and includes a style information item indicating a subtitle display region and a display form of each of the subtitle data items of the group, and
the subtitle reproduction unit generates a reproducible segment data item from each of the segment data items and the common subtitle data item, and displays the group on the subtitle display region in the display form based on the reproducible segment data item.

13. The content reproduction apparatus according to claim 1, wherein each of the segment data items includes a style information item indicating a subtitle display region and a display form of each of the subtitle data items of the group, and
the subtitle reproduction unit displays the group on the subtitle display region in the display form based on the style information item.

14. The content reproduction apparatus according to claim 6, wherein each of the segment data items includes a style information item indicating a subtitle display region and a display form of each of the subtitle data items of the group, and
the subtitle reproduction unit displays the group on the subtitle display region in the display form based on the style information item.

15. The content reproduction apparatus according to claim 1, wherein the segment data items and the content data item are multiplexed and stored in the recording medium.

16. A content reproduction apparatus comprising:
a reproduction unit configured to reproduce a content data item from a recording medium, the recording medium storing the content data item and a plurality of segment data items which are described in a structured document description language, a subtitle reproduction control information item and a common subtitle data item, (a) the segment data items corresponding, respectively, to a plurality of time periods which are segments of a reproduction time period required for reproducing whole of the content data item, and each of the segment, which corresponds to each of the time periods, including a group of subtitle data items to be reproduced within the each of the time periods, (b) the subtitle reproduction control information item representing the time periods and the segment data items corresponding to them, respectively, (c) the common subtitle data item including a style information item indicating a subtitle display region and a display form of each of the subtitle data items of the group; and
a subtitle reproduction unit configured to reproduce the group included in the each of the segment data items while a partial content data part which is to be reproduced within the each of the time periods by the content reproduction unit is reproduced, the each of the segment data items being selected in reference to the subtitle reproduction control information item, and display the group on the subtitle display region in the display form based on the common subtitle data item.

17. A subtitle reproduction method in a content reproduction apparatus comprising a content reproduction unit configured to reproduce a content data item from a recording medium, the recording medium storing the content data item, the method comprising:
acquiring, via a network, a plurality of segment data items which are described in a structured document description language, the segment data items corresponding, respectively, to a plurality of time periods which are segments of a reproduction time period required for reproducing whole of the content data item, and each of the segment data items, which corresponds to each of the time periods, including a group of subtitle data items to be reproduced within the each of the time periods; and
reproducing the group included in the each of the segment data items while a partial content data part which is to be reproduced within the each of the time periods is reproduced by the content reproduction unit.

18. The subtitle reproduction method according to claim 17, wherein the recording medium further stores a subtitle reproduction control information item representing the time periods and the segment data items corresponding to them, respectively, and wherein acquiring acquires the each of the segment data items which is selected in reference to the subtitle reproduction control information item.

19. The subtitle reproduction method according to claim 17, wherein each subtitle data item of the subtitle data items of the group included in each of the segment data items includes an attribute data item representing a reproduction start time of the each subtitle data item,
the reproduction start time of one subtitle data item of the subtitle data items which is reproduced and displayed first, the reproduction start time corresponding to a time from a display ending time point of a subtitle data item displayed immediately before reproduction of the one subtitle data item to a starting time point of reproducing the one subtitle data item,
the reproduction start time of another subtitle data item of the subtitle data items which is reproduced and displayed next to the one subtitle data item, the reproduction start time corresponding to a time from a display ending time point of the one subtitle data item to a starting time point of reproducing the another subtitle data item,
each of the segment data items includes a time correction data item for use in correcting the reproduction start time of the one subtitle data item, and wherein
reproducing starts reproducing the one subtitle data item when a corrected reproduction start time elapses from a starting time point of each of the time periods, the corrected reproduction start time being obtained by correcting the reproduction start time of the one subtitle data item by using the time correction data item, and starts reproducing the another subtitle data item, when the reproduction start time of the another subtitle data item elapses from the display ending time point of the one subtitle data item.

20. The subtitle reproduction method according to claim 17, wherein the recording medium further stores a common subtitle data item which is necessary for reproducing the group and includes a style information item indicating a subtitle display region and a display form of each of the subtitle data items of the group, and
reproducing includes, generating a reproducible segment data item from each of the segment data items and the common subtitle data item, and displays the group on the subtitle display region in the display form based on the reproducible segment data item.

21. The subtitle reproduction method according to claim 17, wherein each of the segment data items includes a style information item indicating a subtitle display region and a display form of each of the subtitle data items of the group, and
reproducing displays the group on the subtitle display region in the display form, based on the style information item.
